(19) United States
(12) Patent Application Publication
(10) Pub. No.: US 2008/0013181 A1
(43) Pub. Date: Jan. 17, 2008

(54) Exterior Mirror or Rear-View Mirror for a Motor Vehicle

(75) Inventors: Andreas Eckardt, Berlin (DE); Hans Driescher, Ruedersdorf (DE)

Correspondence Address: COHEN, PONTANI, LIEBERMAN & PAVANE, 551 FIFTH AVENUE, SUITE 1210, NEW YORK, NY, 10176, US

(73) Assignee: Deutsches Zentrum für Luft-und-Raumfahrt e.V., Koeln (DE)

(21) Appl. No.: 11/629,848

(22) PCT Filed: May 10, 2005
(86) PCT No.: PCT/EP05/05151

§ 371 Date: Jan. 18, 2007

(30) Foreign Application Priority Data
Jun. 17, 2004 (DE) 10 2004 029 876.9

(51) Int. Cl. B60R 1/08

(52) U.S. Cl. 359/608

(57) ABSTRACT

A mirror system includes a highly reflective coating which transmits some light, and a second coating applied on the highly reflective coating, wherein the second coating is subdivided into segments having a transmissivity that can be varied individually by electronic signals. A camera situated behind the highly reflective coating generates image data for light incident on the second coating, and a control unit uses the image data to control the transmissivity of the segments individually so that light reflected by the highly reflective coating through the segments does not exceed an adjustable brightness.

The invention concerns a side-view or rear-view mirror for a motor vehicle in accordance with the introductory clause of Claim 1.

DE 101 55 358 A1 discloses a side-view or rear-view mirror for a motor vehicle, which comprises at least one mirror, wherein the upper surface of the mirror has at least a partial coating, whose transmission can be varied continuously or incrementally by an electronic control signal of a control unit, and at least one photosensitive element, whose signals can be used to estimate a glare effect on an observer, with the estimated glare effect then being supplied to the control unit, which varies the transmission of the coating as a function of the estimated glare effect. The coating is preferably formed as an LCD film, which is subdivided into segments that can be controlled independently of one another. The photosensitive element is arranged between the LCD film and the mirror. A disadvantage of the previously known system is that the photosensitive element must not be so large that the quality of the mirror is adversely affected. On the other hand, estimation of the glare effect is relatively difficult when a small-area photosensitive element is used.

Therefore, the invention is based on the technical problem of creating a side-view or rear-view mirror for a motor vehicle, with which estimation and compensation of the glare effect are improved.

This technical problem is solved by the object with the features specified in Claim 1. Other advantageous embodiments of the invention are disclosed in the dependent claims.

In accordance with the invention, the highly reflective coating is semitransparent, and the photosensitive element is configured as a camera situated behind the highly reflective coating, wherein the camera is used to determine the coordinates of an incident and reflected ray of light, and wherein the control unit can control the associated segments of the second coating in such a way that the reflected light does not exceed an adjustable brightness. The advantage of the camera, which is configured, for example, as a CCD or CMOS matrix camera, is that the entire image content is considered. Since it can be fairly accurately assumed that the incident light is from a source at infinity, the incident light is approximately parallel. In this case, a space segment from which the incident light came can be uniquely assigned to each image point on the camera. The reflection law can then be used to determine the region of the coating where the reflected ray of light passes through. The transmissivity of this region can then be systematically reduced to reduce glare. The threshold values above which a reduction is undertaken and the values of the attenuation can be adjusted individually and adapted to ambient conditions (e.g., ambient brightness). To ensure that some light is incident on the camera, the highly reflective coating must transmit a portion of the light, but this portion can be so small that these transmission losses are not perceptible by the observer.

The second coating is preferably formed as an LCD film.

In another preferred embodiment, a transparent substrate with an antireflection coating is applied on the second coating and/or behind the first coating. This substrate serves the twofold purpose of mounting and passivation. In this regard, especially the second coating or LCD film is mechanically securely joined with the substrate.

In another preferred embodiment, the highly reflective coating has a transmissivity of 1-10%, and the transmission is preferably selected as low as possible, as long as sufficient brightness on the camera is realized.

In another preferred embodiment, the system has a device for detecting or determining the angle of view of an observer. An angle of view can be estimated with the use of an additional camera and, for example, by means of the mirror position and the seat position.

In another preferred embodiment, additional photosensitive sensors, which are situated in differently oriented, funnel-like openings, are arranged in the marginal regions of the system. This allows a rearward viewing direction to be determined. This data can be matched with data of the camera and/or data of the device for detecting or determining the angle of view.

In another preferred embodiment, the control signals of the control unit are configured as alternating-current voltage signals, preferably in the form of square-wave voltage. In this regard, the frequency is preferably selected greater than or equal to 50 Hz, so that the variation is imperceptible due to the sluggishness of the human eye, and the pulse duty factor between pulse-on time and pulse-off time can be varied according to the degree of glare. The frequency is more preferably greater than or equal to 200 Hz, so that even finer gradation of the transmission is possible.

In another preferred embodiment, the coating is transparent in the absence of an applied potential. This ensures that mirror function is preserved in the event of failure of the control unit and/or the supply voltage. The coating is also preferably electrically uncoupled if a continuous pulse is detected, for example, due to a short circuit to supply voltage. Furthermore, a manual switch is preferably provided, by which the control unit can be shut off.

The invention is explained in greater detail below with reference to a preferred embodiment.

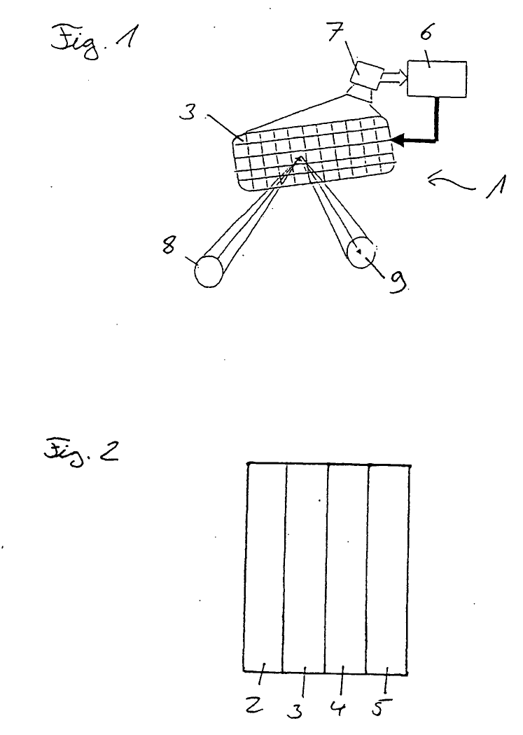

FIG. 1 is a schematic view of a mirror system in accordance with the invention.

FIG. 2 is a side view through the system.

The mirror system 1 comprises a substrate layer 2, an LCD film 3, a highly reflective coating 4, and another substrate layer 5, as shown in FIG. 2. The LCD film is configured in segments, and the individual segments can be controlled independently of each other. The substrate layer 2, 5 consists of transparent material of good optical quality with an anti-reflection coating. The transmissivity of the LCD film 3 can be adjusted from 0 to 100% by electrical control signals of a control unit 6, and the highly reflective coating 4 behind the LCD film 3 has, for example, a reflectivity of about 99%. A camera 7, which records a complete image of the light incident on the mirror 1, is positioned behind the substrate layer 5. The camera 7 then supplies the data to the control unit 6, which then controls the LCD film 3. An incident light spot 8 first passes through the substrate layer 2 and the LCD film 3 and is then reflected as light spot 9 on the highly reflective coating 4, except for about 1%, which is transmitted and is incident on the camera 7. The light spot 8 incident on the focal plane of the camera 7 is analyzed with respect to its coordinates. The coordinates can then be used to determine the space segment of the incident light spot 8 and thus, by applying the reflection law, the space segment of the reflected light spot 9. The control unit 6 thus also knows the segment of the LCD film 3 through which the reflected light spot 9 passes and can systematically reduce the transmissivity of this segment if the brightness of the incident light spot 8 exceeds a threshold value.

1.-10. (canceled)

11. A side-view or rear-view mirror system for a motor vehicle, comprising:
a highly reflective coating which transmits some light;
a second coating applied on the reflective coating, said second coating being subdivided into segments having a transmissivity that can be varied individually by electronic signals;
a camera situated behind the highly reflective coating, the camera generating image data for light incident on the second coating; and
a control unit which uses the image data to control the transmissivity of the segments individually so that light reflected by the highly reflective coating through the segments does not exceed an adjustable brightness.

12. The mirror system of claim 11 wherein the second coating is an LCD film.

13. The mirror system of claim 11 further comprising a transparent substrate with an anti-reflection coating on at least one of said highly reflective coating and said second coating.

14. The mirror system of claim 13 wherein a transparent substrate with an anti-reflective coating is mechanically securely joined to the second coating.

15. The mirror system of claim 11 wherein the highly reflective coating has a transmissivity of 1-10%.

16. The mirror system of claim 11 further comprising means for determining an angle of view of an observer.

17. The mirror system of claim 11 further comprising photosensitive sensors situated in differently oriented funnel-like openings in marginal areas of the system.

18. The mirror system of claim 11 wherein the control unit generates control signals which are configured as alternating current voltage signals.

19. The mirror system of claim 18 wherein the frequency of the voltage signals is greater than or equal to 200 Hz.

20. The mirror system of claim 11 wherein the second coating is substantially transparent in the absence of an applied voltage.
